(19) United States
(12) Patent Application Publication
(10) Pub. No.: US 2003/0018903 A1
(43) Pub. Date: Jan. 23, 2003

(54) Method of containing spread of computer viruses

(76) Inventors: Damon G. Della Greca, White Plains, NY (US); Louis J. Della Greca, White Plains, NY (US)

Correspondence Address: WECHSLER & WECHSLER, P.C., Suite 9, One Barstow Road, Great Neck, NY, 11021, US

(21) Appl. No.: 10/103,550

(22) Filed: Mar. 19, 2002

Related U.S. Application Data
(60) Provisional application No. 60/277,215, filed on Mar. 19, 2001.

(51) Int. Cl. H04L 9/32

(52) U.S. Cl. 713/188

(57) ABSTRACT

A method of containing the spread of computer viruses provides a registered computer user with an early warning of a potential virus threat in advance of execution of suspected e-mail attachments. Internet users sign up to become a registered member of a virus warning service administered by a service provider. Each member of such service is instructed to enter one or more unique identifiers, such as, for example, designated addresses in their address book and/or buddy list. Such designated address is advantageously an address of the service provider dedicated to receiving e-mails sent unintentionally by members, such that if an e-mail is sent to the designated address from a registered member of the virus warning system, it can be reasonably assumed, or at least suspected, by the service provider of the virus warning system, that such e-mail has been sent as a result of an infected file. In the event an e-mail is received at one of the dedicated e-mails of the service provider and entered in the address book and/or buddy list of each of the registered members, the registered user from whom the e-mail is received is advantageously contacted, and an inquiry is made as to whether the particular e-mail was intentionally sent to the address. If the user verifies that the e-mail was not intentionally sent, all other registered members are notified of the potential danger of the attachment, and advises that such attachment not be opened.

### CROSS REFERENCE TO RELATED APPLICATIONS

This application claims the benefit of U.S. Provisional Application No. 60/277,215 filed Mar. 19, 2001 entitled METHOD OF CONTAINING SPREAD OF COMPUTER VIRUSES.

### BACKGROUND OF THE INVENTION

The present invention relates to a method of containing the spread of computer viruses, and more particularly, to a method by which the spread of computer viruses transferred between computers as e-mail attachments can be contained by an early detection and warning system.

A computer virus is simply a program comprising a list of executable instructions. It can, for example, take the form of an executable file than has an EXE extension, a macro, or it can attach itself to an existing executable file. Popular applications, such as, EXCEL.EXE of WORD.EXE, can, for example, serve as a host for an attached virus.

For a virus to infect a computer, it must be executed. This requires that it be loaded into main memory (RAM) and subsequently run. Simply double clicking a mouse on the selected file is sufficient to run the infected program.

In addition to the primary object of corrupting data and other files on the infected computer, a second object of the virus is generally to spread itself to other computers. A widespread mode of transmission is via the Internet, or network, where the virus is received by unsuspecting computer users as an email attachment sent by the infected computer. The virus commonly creates the attachment and sends it to everyone in the address book and/or the buddy list of the originally infected computer. This process is then repeated by the subsequently infected computers when the e-mail attachment received thereby is executed.

In an attempt to provide the computer user with a safeguard against such viruses, anti-virus software has been developed which scans stored files, and which looks for a virus signature. A virus may display a key phrase identifying it as a particular virus. For example, a recently created virus displayed to the computer user the phrase “I love you” on the monitor when executed. Therefore, one way the anti-virus software detects such virus, is to look for the particular phrase associated therewith, such as “I love you” in the example, embedded in the scanned file. Although providing effective protection against infection by previously identified viruses, such anti-virus software does not adequately safeguard against newly created viruses. Since new viruses are constantly being developed which do not match existing criteria for recognition, anti-viral software do not adequately insure against infection.

Another way of detecting viruses imbedded in a program is by use of a digital signature. A digital signature is a unique number that identifies a file's source and whether a file has been changed as the file made its way across the internet. Knowing that a file has a digital signature is not enough, however, since anyone can buy a digital I.D. and create a digital signature.

Consequently, a method of detecting the existence of a newly created virus in an e-mail attachment and which warns computer users of a potential threat in advance of execution of the suspect files would be highly desirable, since such method would effectively safeguard against even newly created, and heretofore unknown viruses.

Accordingly, it is an object of the invention to provide a method of containing the spread of computer viruses which overcomes the drawbacks of the prior art.

It is a further object of the invention to provide a method of containing the spread of computer viruses which provides an early warning to computer users in advance of execution of e-mail attachments containing such viruses.

It is yet a further object of the invention to provide a method of containing the spread of computer viruses which provides a sender of e-mail with an indication that he/she may be potentially contaminated with a virus.

It is still a further object of the invention to provide a method of containing the spread of computer viruses which is available to computer users by logging onto an on-line website, and which can be accessed in advance to permit the user to register with a warning system which will immediately alert the user of a potential virus threat in response to receipt by another registered user of a suspect e-mail attachment.

### SUMMARY OF THE INVENTION

In accordance with these and other objects of the invention, there is provided a method of containing the spread of computer viruses, in accordance with which a registered computer user is provided with an early warning of a potential virus threat in advance of execution of e-mail attachments containing such a virus and/or notifying the sender of such e-mail that they are potentially infected.

Briefly stated, the method allows internet users to sign up to become a registered member of a virus warning service administered by a service provider. Each member of such service is instructed by the service provider of the virus warning system to enter one or more unique identifiers associated with the service provider into their computer. For purposes herein, the term “unique identifier” is defined as information which uniquely identifies the service provider for receipt of information sent by the service subscriber. For example, a unique identifier may be one or more designated addresses which are entered in the member's address book and/or BUDDY LIST. Such designated address is advantageously an address of the service provider dedicated to receiving emails sent unintentionally by members, such that if an e-mail is sent to the designated address from a registered member of the virus warning system, it can be reasonably assumed, or at least suspected, by the service provider of the virus warning system, that such e-mail has been sent as a result of an infected file. Another example of a unique identifier is screen name unique to the service provider, and similarly advantageously applied to a particular computer system dedicated to receiving communication only for the intended monitoring purposes in accordance with the invention, which the subscribing member enters as a chat client name (in such applications as, for example, AOL Instant Messanger, Yahoo, ICQ, etc.). It is noted that for purposes of simplifying disclosure, the invention is explained primarily by example of e-mail transmission. However, it is to be understood that the invention is intended to broadly embrace all communications sent to the service provider based upon any unique identifier associated with the service provider, and which identifier enables the registered member to send messages of any type to the service provider. It will be further understood, that when the disclosure herein refers to entering the service provider's e-mail address into a member's e-mail address book and/or BUDDY LIST, any such disclosure can be applied by analogy to any information stored in an appropriate file in the member's computer for purposes of allowing the member's computer to communicate with the service provider.

In order to avoid falsely alarming registered members of the virus warning system, the inventive monitoring method advantageously provides that, in the event an e-mail (or other communicated message) is received at one of the dedicated e-mails (or as a screen message) of the service provider and entered in the address book and/or BUDDY LIST (chat clients) of each of the registered members as mentioned above, the registered user from whom the e-mail or other communication is received is contacted, and an inquiry is made as to whether the particular e-mail was intentionally sent to the address. If the user verifies that the e-mail was not intentionally sent, the file sent may have a virus, and the service provider then notifies all other registered members of the potential danger of the attachment, and advises that such attachment not be opened.

The above, and other objects, features and advantages of the present invention will become apparent from the following description read in conjunction with the accompanying drawings.

### BRIEF DESCRIPTION OF THE DRAWINGS

FIG. 1 is a flow chart depicting a practical implementation of an embodiment of a method in accordance with the invention detailing the steps carried out from registration of a member of a virus warning system through subsequent early warning of a virus threat; and

FIG. 2 is an example of a typical on-screen subscription form for registration of a member for the virus warning system in accordance with an embodiment of the invention.

### DETAILED DESCRIPTION OF THE INVENTION

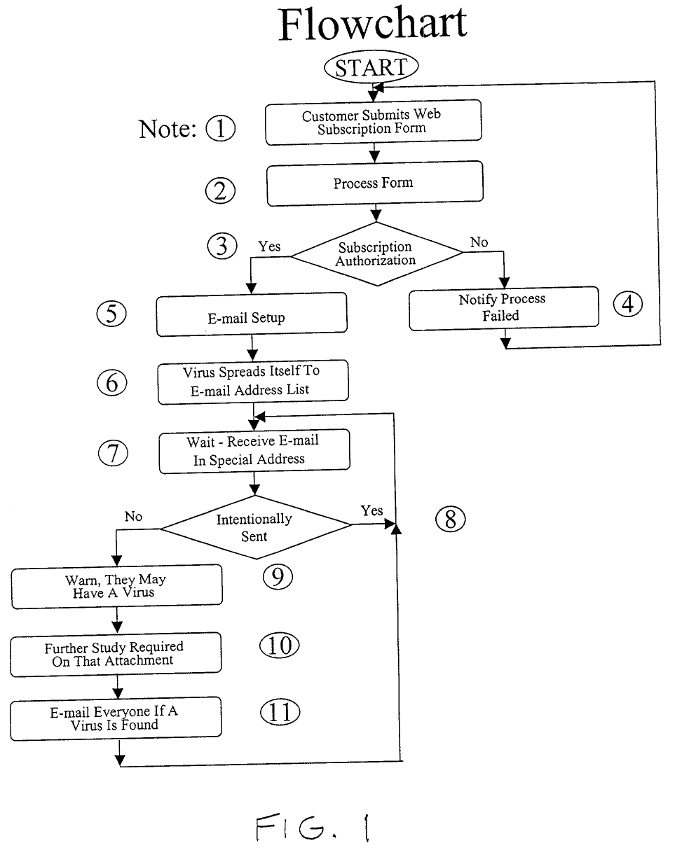

A flow chart of a typical example of implementation is depicted in FIG. 1. The chart is not to be construed as limiting of the broad concept disclosed and embraced herein, but is rather for purposes of clarifying a convenient commercial implementation of the invention. The disclosed example of the registration procedure can be simplified or changed without departure from the intended scope of the invention. Moreover, other modes of sign-up can be used, such as, phone, mail or other registration techniques.

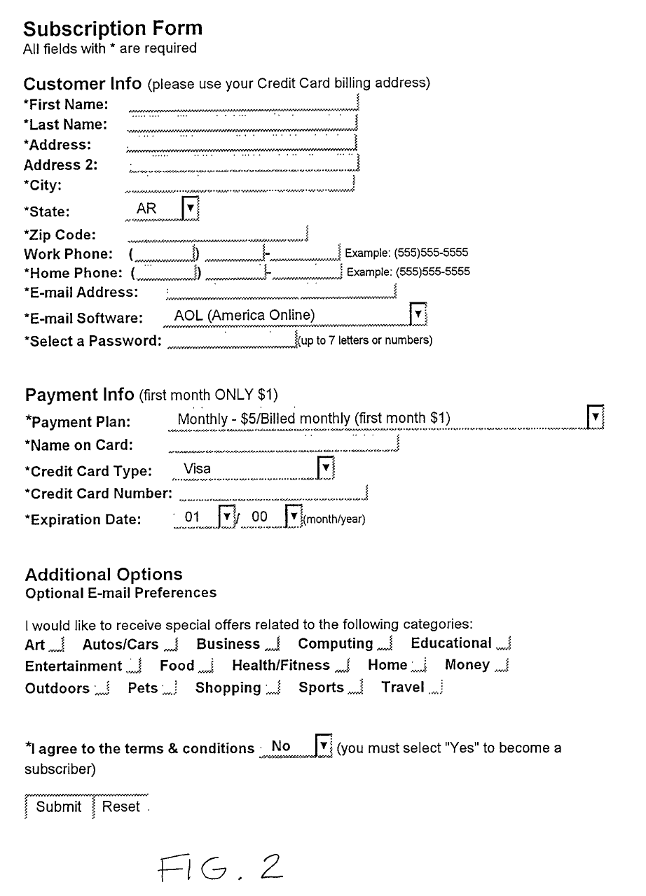

In step 1, a prospective customer visits the service provider's web site, fills out a subscription form (an example is shown in FIG. 2), and submits the completed form. The subscription form is processed, first by applying for authorization of payment from the credit card in step 2. The provider checks in step 3 whether authorization is successful. If authorization has failed, the service provider notifies the potential customer in step 4 that the process failed, and that such information should be resubmitted with valid data. If the credit card is authorized in step 3, the new customer is added to the service provider's database, and instructions are sent to the customer regarding how to set up their address book and BUDDY LIST with a special e-mail address of the service provider. When a computer of a customer (i.e., any subscriber of the service provider's virus warning system) is then infected by a virus, it may spread (step 6) by sending itself as an attachment to everyone in that customer's address book and/or BUDDY LIST. In such case, therefore, it will send itself to the special e-mail address of the service provider, as indicated by step 7. This address is intended for use only to receive e-mails with potential virus attachments, and not for other e-mail communications. In step 8, a verification is initially made as to whether the sender intentionally sent the e-mail to the special address. If not, the potential of a virus threat exists. If the sender did not send the e-mail intentionally, the sender is informed of a potential virus threat in step 9. In order to avoid false alarms to the subscribers, other customers are advantageously not yet informed that a virus in fact exists, pending further investigation in step 10. This investigation involves, for example, a study of the attachment to determine if it is a virus or not. In step 11, all subscribers of the service are contacted regarding the findings.

Since time may be of the essence in containing the potential for damage caused by many viruses, the virus containment method in accordance with the invention may optionally provide for immediate notification of all customers of a receipt of any e-mails in the special e-mail address of the service provider, with the qualifying notification that such e-mail is merely suspect, and not yet confirmed. This might for example be termed a virus “watch.” The subscribers would then be told that further updates would be sent, either indicating that the threat was real, or calling off the threat. When the sender of the e-mail suspected of the virus threat confirms to the service provider that he did not intend to send the e-mail, the subscribers would be notified by further e-mail that the situation is upgraded, for example, to a virus “warning.” After confirmation in step 10 that indeed a virus is involved, the subscribers would be sent a yet a further upgrade, characterizing the state of alert as a virus “confirmation.”

Although described above with particular reference to e-mail attachments, the method in accordance with embodiment of the invention may also be applied to any communication received by the service provider which is sent without the express intention of the registered member, and which could present potentially harmful consequences to a recipient. For example, an instant screen message may be sent which instructs the recipient to visit a website which may present a virus threat by download, etc. Such communication sent to the service provider (via use of the service provider's screen name provided to the subscribing member) is therefore treated in analogous manner to a received e-mail.

In a further embodiment of the invention, the service provider optionally provides members with a warning system, in addition the above described monitoring service, which keeps registered members apprised of current threats regarding viruses periodically detected by the service provider and/or learned about generally via news services, etc. In accordance with such warning system, when the service provider's system (e-mail server, chat software, etc.) detects a virus with a pattern of activity, subscribing members are sent an e-mail, notifying them of the potential threat. For example, the notification may contain information, such as, file name, description of spreading methods, etc., which information can at least alert the members to be on the lookout for such suspicious material.

Although the above described monitoring method is most advantageously practiced with more than one member, since such practice allows other members not yet infected to be warned when another of the members sends an unintentional e-mail or communication to the service provider, the method still provides utility when only one member is registered. In such instance the infected member can at least be made aware of the infection, and the imminent threat to files stored on his/her computer as well as the danger he/she potentially poses to others, such that the necessary steps can be taken to contain the problem and/or to back up any important data.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A method of containing the spread of computer viruses, comprising the steps of:
registering at least two members for participation in a virus warning system;
providing said at least two members with at least one designated e-mail address which is subsequently entered in at least one of an address book and a buddy list of a computer used by each of said at least two members;
monitoring said at least one designated e-mail address for any email sent by a one of said at least two members; and
notifying another of said at least two members of a potential virus threat in response to reception of an e-mail at said at least one designated e-mail sent by said one of said at least two members.

2. A method of containing the spread of computer viruses, comprising the steps of:
registering a member for participation in a virus warning system run by a service provider;
providing said member with at least one unique identifier associated with the service provider which is subsequently entered in a computer used by said member;
monitoring for a communication sent by said member to said service provider; and
notifying said member of a potential virus threat in response to reception of a communication sent by said member to said service provider using said unique identifier.

3. A method according to claim 2, wherein said unique identifier is dedicated to receiving information exclusive to practice of the method.
